(19) United States
(12) Patent Application Publication
(10) Pub. No.: US 2013/0139793 A1
(43) Pub. Date: Jun. 6, 2013

(54) EXHAUST GAS PROCESSING DEVICE

(71) Applicants: Ji Hong Pak, Hwaseong-si (KR); Jong Ik Chun, Seoul (KR)

(72) Inventors: Ji Hong Pak, Hwaseong-si (KR); Jong Ik Chun, Seoul (KR)

(73) Assignees: Kia Motors Corporation, Seoul (KR); Hyundai Motor Company, Seoul (KR)

(21) Appl. No.: 13/489,777

(22) Filed: Jun. 6, 2012

(30) Foreign Application Priority Data
Dec. 1, 2011 (KR) 10-2011-0127971

(51) Int. Cl. F02M 25/07

(52) U.S. Cl. 123/568.2

(57) ABSTRACT

An exhaust gas treatment system includes: confirming that an engine stops operation; sensing present pressure difference between front and rear sides of an EGR value; setting learning value by performing large offset learning, if the present pressure difference exceeds an absolute value of a first lower or upper values; setting learning value by performing step learning, if the present pressure difference exists between first and second lower values that is larger than the first lower value or the present pressure difference a between first and second upper values that is smaller than the first upper value; and setting the present pressure difference value as a learning value, if the present pressure difference exists between the second lower and second upper values. The exhaust gas treatment method accurately learns the pressure difference of the EGR system to improve the quality of the exhaust gas and securely control the EGR system.

### CROSS-REFERENCE TO RELATED APPLICATION

The present application claims priority of Korean Patent Application Number 10-2011-0127971 filed Dec. 1, 2011, the entire contents of which application is incorporated herein for all purposes by this reference.

### BACKGROUND OF INVENTION

1. Field of Invention

The present invention relates to an exhaust gas treatment method that improves quality of exhaust gas by accurately learning a pressure difference of the EGR system while a negative pressure is formed in an exhaust line.

2. Description of Related Art

Generally, after a vehicle stops its operation, a front/rear pressure of an EGR valve is learned, and the pressure difference learning can be performed in a vacuum condition in which a negative pressure is formed in at least one side of an exhaust line.

The negative pressure is a value that is generated while exhaust gas is sucked by a separate device in a test site so as to measure the exhaust gas or exhaust the exhaust gas to the outside, and in a case that the negative pressure is −10 hpa, the pressure difference of the EGR system is increased as much as +10 hpa.

Particularly, because an EGR line is diverged from a downstream side of a DPF in an LP-EGR system, when a negative pressure is formed in an exhaust line, a fluctuation width of the pressure difference can be increased, and when this fluctuated value is learned, the control system can be abnormal.

Further, because the pressure difference of the EGR system is differently measured, nitrogen oxide and particulate matter that are sensitively regulated can be excessively increased.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an exhaust gas treatment system including confirming that an engine stops its operation; sensing a present pressure difference between a front side and a rear side of an EGR value of an EGR line by using a pressure difference sensor; setting a learning value by performing large offset learning, if the present pressure difference exceeds an absolute value of a first lower value or a first upper value; setting a learning value by performing step learning, if the present pressure difference exists between the first lower value and a second lower value that is larger than the first lower value or the present pressure difference a between the first upper value and a second upper value that is smaller than the first upper value; and setting the present pressure difference value as a learning value, if the present pressure difference exists between the second lower value and the second upper value.

The large offset learning may include storing the present pressure difference value detected by the pressure difference sensor by as much as a predetermined frequency at a predetermined interval, and setting an averaged value except a maximum value and a minimum value from the stored values as a learning value.

While storing the present pressure difference value detected by the pressure difference sensor by as much as a predetermined frequency, if the predetermined frequency is not stored, a former pressure difference value may be used to be a learning value.

The step of learning may include subtracting a first predetermined value from a former learning value to set a learning value.

The first predetermined value that is subtracted may correspond to a negative pressure that is formed in an exhaust line.

The first predetermined value may be a value that exists between the second lower value and the second upper value.

Various aspects of the present invention provide for an exhaust gas treatment method that accurately learns the pressure difference of the EGR system to improve the quality of the exhaust gas and securely control the EGR system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary exhaust gas treatment device according to the present invention.

FIG. 2 is a flowchart showing an exemplary exhaust gas treatment method according to the present invention.

FIG. 3 is a graph showing an exemplary exhaust gas treatment method according to the present invention.

FIG. 4 is a flowchart showing large offset learning logic in an exemplary exhaust gas treatment method according to the present invention.

FIG. 5 is a table showing an example of large offset learning logic in an exemplary exhaust gas treatment method according to the present invention.

FIG. 6 is a flowchart showing step learning logic in an exemplary exhaust gas treatment method according to the present invention.

FIG. 7 is a graph showing an example of step learning logic in an exemplary exhaust gas treatment method according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

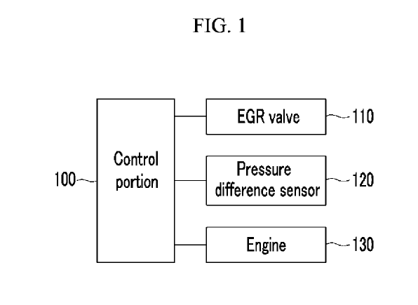

FIG. 1 is a schematic diagram of an exhaust gas treatment device according to various embodiments of the present invention.

Referring to FIG. 1, an exhaust gas treatment device includes an EGR valve 110, a pressure difference sensor 120, an engine 130, and a control portion 100. The engine 130 exhausts exhaust gas to the outside through an exhaust line, and an EGR line, which recirculates exhaust gas of a downstream side of the diesel particulate filter (DPF) to an intake line, is formed in the exhaust line.

The EGR valve 110 is disposed on the EGR line to control the flow rate of the EGR gas, the control portion 100 learns a front and rear pressure difference of the EGR valve 110 to control the EGR valve 110, and the learned value is used to control the engine 130.

The pressure difference sensor 120 can be disposed to detect the front and rear pressure difference of the EGR valve 110.

An EGR system according to various embodiments of the present invention is a low pressure type (LP-EGR system) where the exhaust gas is diverged from a downstream side of the diesel particulate filter to be transferred to an intake line.

Further, a high pressure type (HP-EGR system) recirculates the exhaust gas from an upstream side of the diesel particulate filter to an intake line. The HP-EGR system can be applied in various embodiments of the present invention instead of the LP-EGR system.

The control portion 100 detects a condition of the engine, and if it is determined that the engine stops operation, the front/rear pressure difference of the EGR valve 110 is learned by the control portion through the pressure difference sensor 120 in various embodiments of the present invention.

Particularly, when a vacuum line is connected to the exhaust line, the front/rear pressure difference of the EGR valve 110 is sharply fluctuated and a control factor such as nitrogen oxide is also varied, and therefore it is necessary to accurately detect the front/rear pressure difference of the EGR valve 110.

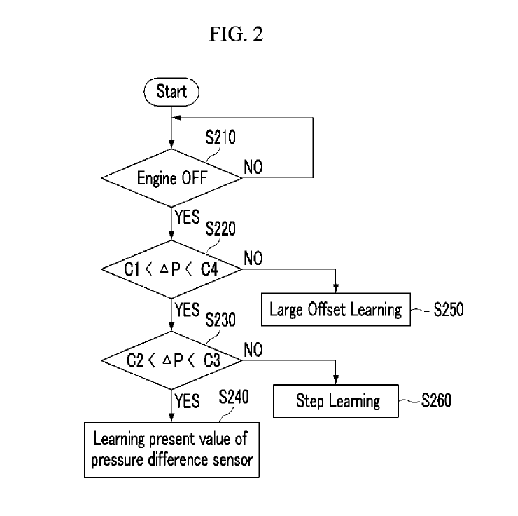

FIG. 2 is a flowchart showing an exhaust gas treatment method according to various embodiments of the present invention.

Referring to FIG. 2, control starts in S200, and it is confirmed that the engine 130 is stopped in S210.

It is determined whether a pressure difference value of the pressure difference sensor 120 exists between a first lower value C1 and a first upper value C4 in S220, and if it is determined that the present pressure difference value (ΔP) exceeds a range of the first lower value C1 and the first upper value C4, S250 is performed.

Further, if the present pressure difference value (ΔP) is included in the range of the first lower value C1 and the first upper value C4, S230 is performed. If the present pressure difference value (ΔP) exists between the second lower value C2 that is larger than the first lower value C1 and the second upper value C3 that is smaller than the first upper value C4 in S230, S240 is performed.

The size relation is “the first lower value C1>the second lower value C2 >the second upper value C3>the first upper value C4”.

The present pressure difference value (ΔP) that is detected in the pressure difference sensor 120 is set as a learning value in S240. For example, when it is assumed that C1=−5, C2=−3, C3=3, and C4=5, the present pressure difference value (ΔP) that is detected by the pressure difference sensor 120 is −1, a learning value is set as −1. The learning value is used as a new control factor in the control portion 100.

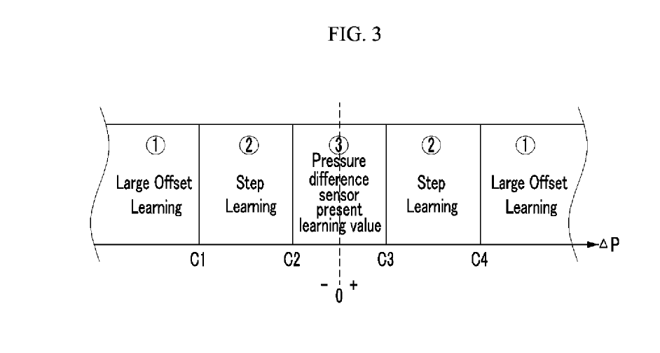

FIG. 3 is a graph showing an exhaust gas treatment method according to various embodiments of the present invention.

Referring to FIG. 3, C1 (the first lower value), C2 (the second lower value), C3 (the second upper value), and C4 (the first upper value) are set as reference values, and if the present pressure difference value (ΔP) exists between C2 (the second lower value) and C3 (the second upper value), the value is set as a learning value.

Further, if the present pressure difference value (ΔP) is included between C1 (the first lower value) and C2 (the second lower value) or is included between C3 (the second upper value) and C4 (the first upper value), step learning is performed, and if the value (ΔP) exceeds C1 (the first lower value) and C4 (the first upper value), a large offset is performed.

The present pressure difference value (ΔP) accurately coincides with C1 (the first lower value), C2 (the second lower value), C3 (the second upper value), or C4 (the first upper value) in various embodiments of the present invention, for example, if the present pressure difference value (ΔP) is C1 (the first lower value), large offset learning or step learning can be performed according to a design specification.

The boundary values such as C1, C2, C3, and C4 can be variably applied in various embodiments of the present invention.

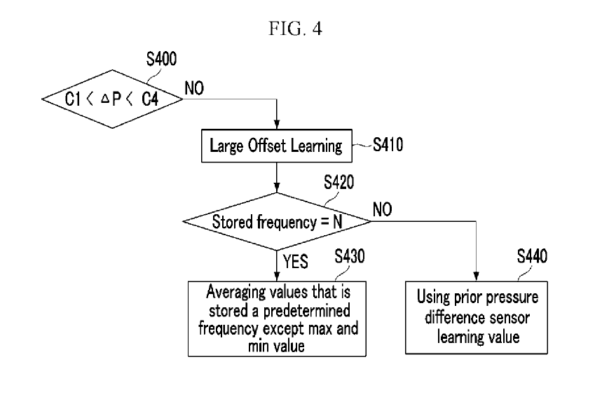

FIG. 4 is a flowchart showing large offset learning logic in an exhaust gas treatment method according to various embodiments of the present invention.

Referring to FIG. 4, it is determined whether the present pressure difference value (ΔP) exists between the first lower value C1 and the first upper value C4 in S400, and if the value exceeds the range, S410 is performed.

The present pressure difference value (ΔP) is stored in S410, the value is stored N times at a predetermined interval in S420, a maximum value and a minimum value among values that are stored N times are excluded in S430, and the average value of the values that are not excluded is calculated. This average value is set as the learning value.

In S420, if the stored frequency does not reach N, a prior learning value of the pressure difference sensor is reused.

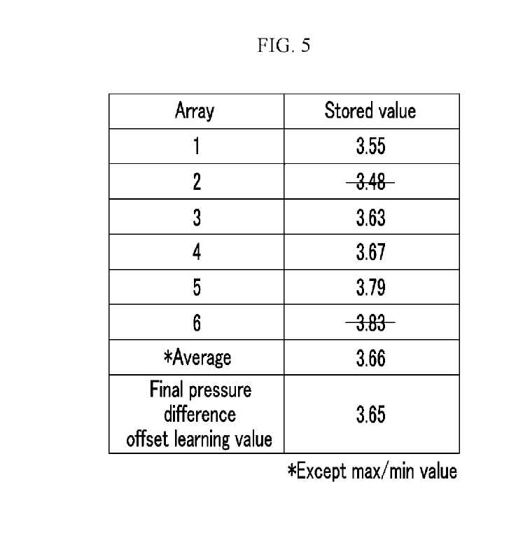

FIG. 5 is a table showing an example of large offset learning logic in an exhaust gas treatment method according to various embodiments of the present invention.

Referring to FIG. 5, a present pressure difference value is stored six times, a maximum value of 3.83 and a minimum value of 3.48 are erased, an average value of the values remaining is 3.65, and the 3.65 is set as a learning value of a final pressure difference offset.

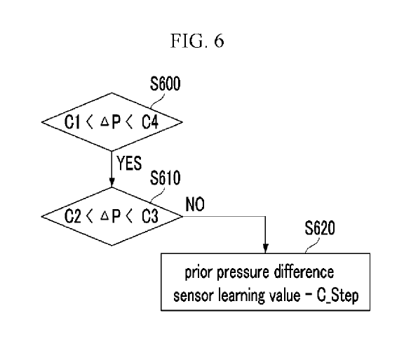

FIG. 6 is a flowchart showing step learning logic in an exhaust gas treatment method according to various embodiments of the present invention.

Referring to FIG. 6, if the present pressure difference value (ΔP) exists within the first lower value C1 and the first upper value C4 in S600 and the present pressure difference value (ΔP) does not exist between the second lower value C2 and the second upper value C3 in S610, S620 is performed.

In S620, a first predetermined value (C_Step) is subtracted from a learning value of a prior pressure difference sensor 120 value and a new learning value is set. It is desirable that the first predetermined value (C_Step) is included between the second lower value C2 and the second upper value C3. Further, the first predetermined value (C_Step) can correspond to a value of a negative pressure that is formed in the exhaust line.

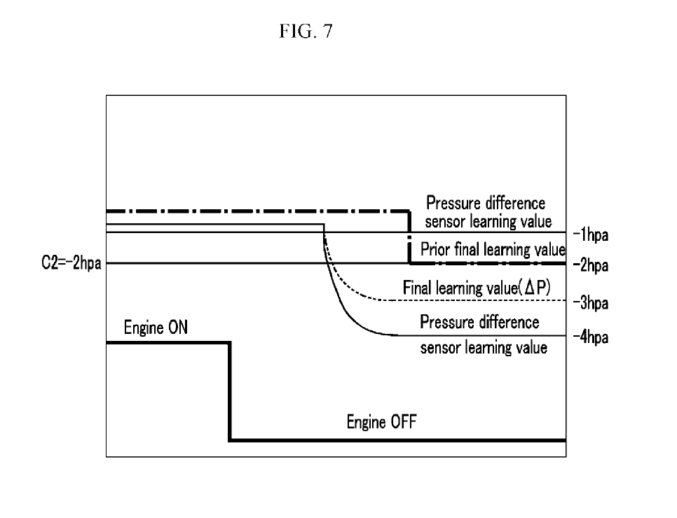

FIG. 7 is a graph showing an example of step learning logic in an exhaust gas treatment method according to various embodiments of the present invention.

Referring to FIG. 7, when the first lower value C1 is −5, the second lower value C2 is −2, the second upper value C3 is 2, the first upper value C4 is 5 hpa, a prior final learning value is −2, and a present offset learning value is −3, a present value of the pressure difference sensor is −4. Further, the first predetermined value is 1 hpa.

That is, when a present pressure difference value of the pressure difference sensor 120 is −4, if step learning is performed and the first predetermined value of 1 is subtracted from a prior final learning value of −2 according to step learning flow, the present final learning value is −3 hpa.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas treatment system, comprising:
confirming that an engine stops operation;
sensing a present pressure difference between a front side and a rear side of an EGR value of an EGR line by using a pressure difference sensor;
setting a learning value by performing large offset learning, if the present pressure difference exceeds an absolute value of a first lower value or a first upper value;
setting a learning value by performing a step learning to, if the present pressure difference exists between the first lower value and a second lower value that is larger than the first lower value or the present pressure difference exists between the first upper value and a second upper value that is smaller than the first upper value; and
setting the present pressure difference value as a learning value, if the present pressure difference exists between the second lower value and the second upper value.

2. The exhaust gas treatment system of claim 1, wherein the large offset learning includes:
storing the present pressure difference value detected by the pressure difference sensor by as much as a predetermined frequency at a predetermined interval; and
setting an averaged value except a maximum value and a minimum value from the stored values as a learning value.

3. The exhaust gas treatment system of claim 2, wherein while storing the present pressure difference value detected by the pressure difference sensor by as much as a predetermined frequency, if the predetermined frequency is not stored, a former pressure difference value is used to be a learning value.

4. The exhaust gas treatment system of claim 1, wherein the step of learning includes subtracting a first predetermined value from a former learning value to set a learning value.

5. The exhaust gas treatment system of claim 4, wherein the first predetermined value that is subtracted corresponds to a negative pressure that is formed in an exhaust line.

6. The exhaust gas treatment system of claim 4, wherein the first predetermined value is a value that exists between the second lower value and the second upper value.
